(19) United States
(12) Patent Application Publication
(10) Pub. No.: US 2025/0321433 A1
(43) Pub. Date: Oct. 16, 2025

(54) LIGHT HOMOGENIZING ASSEMBLY, PROJECTION OPTICAL UNIT, AND PROJECTION DEVICE

(71) Applicant: SHENZHEN HOLATEK CO., LTD, Shenzhen (CN)

(72) Inventors: Guofeng Yan, Shenzhen (CN); Cong Zhang, Shenzhen (CN); Zhenyu Hu, Shenzhen (CN)

(21) Appl. No.: 18/870,023

(22) PCT Filed: Feb. 10, 2023
(86) PCT No.: PCT/CN2023/075519

§ 371 Date: Nov. 27, 2024

(30) Foreign Application Priority Data
Jun. 2, 2022 (CN) 202210625784.1

(51) Int. Cl. G02B 27/30; G02B 27/00

(52) U.S. Cl. CPC G02B 27/30; G02B 27/0025

(57) ABSTRACT

Embodiments of the present disclosure propose a light homogenizing assembly, a projection optical unit and a projection device. The light homogenizing assembly includes a first light homogenizing member, a light-spot shaping lens group and a second light homogenizing member, which are sequentially arranged along an optical path. The first light homogenizing member is configured to homogenize light emitted by a light source. The light-spot shaping lens group includes at least one light-spot shaping lens. The light-spot shaping lens is configured to shape light spots of light emitted by the first light homogenizing member and to emit the light spots to a light incident side of the second light homogenizing member. The second light homogenizing member is configured to homogenize light emitted by the light-spot shaping lens group.

### CROSS-REFERENCE TO RELATED APPLICATIONS

The present disclosure claims the priority of Chinese Patent Application No. 202210625784.1, filed with the China National Intellectual Property Administration on Jun. 2, 2022, and entitled “LIGHT HOMOGENIZING ASSEMBLY, PROJECTION OPTICAL UNIT, AND PROJECTION DEVICE”, all of which are incorporated herein by reference.

### TECHNICAL FIELD

The present disclosure relates to the technical field of projection devices, and particularly, to a light homogenizing assembly, a projection optical unit and a projection device.

### BACKGROUND

In the related art, how to design a projector having a simple structure, a uniform color and a good speckle elimination effect is always a problem concerned by manufacturers.

Current solutions are mainly realized by using a diffusion sheet and some dynamic elements, but the effect is not very ideal, or the volume and the cost are not as long as possible, even further, a jitter design of a projection screen is added, which is very unfavorable to the user experience.

In addition, some optical elements such as a conventional compound eye lens are used for integral light homogenization, but the effect is not ideal, and the light cannot be well homogenized, so that the image at the projection still has color spots, and the high-time and spatial coherence of the light cannot be reduced.

### SUMMARY OF THE DISCLOSURE

According to various embodiments of the present disclosure, a light homogenizing assembly, a projection optical unit and a projection device are provided.

According to an embodiment of a first aspect of the present disclosure, a light homogenizing assembly is provided. The light homogenizing assembly includes a first light homogenizing member, a light-spot shaping lens group and a second light homogenizing member sequentially arranged along an optical path. The first light homogenizing member is configured to homogenize light emitted by a light source. The light-spot shaping lens group includes at least one light-spot shaping lens, the at least one light-spot shaping lens is configured to shape a light spot of light emitted from the first light homogenizing member and emit the light to a light incident side of the second light homogenizing member. The second light homogenizing member is configured to homogenize light emitted from the light-spot shaping lens group.

According to an embodiment of the present disclosure, the second light homogenizing member includes a light homogenizing element and a first lens group, the first lens group includes at least one lens, and the lens is configured to focus or collimate light; and the light homogenizing element is on a light incident side of the first lens group and configured to homogenize the light emitted from the light-spot shaping lens group.

According to an embodiment of the present disclosure, the second light homogenizing member includes a light homogenizing element and a first lens group, the first lens group includes at least one lens, and the lens is configured to focus or collimate the light; and the light homogenizing element is on a light exit side of the first lens group and configured to homogenize light emitted from the first lens group.

According to an embodiment of the present disclosure, the second light homogenizing member includes a light homogenizing element and a first lens group, the first lens group includes at least one lens, and the lens is configured to focus or collimate the light; and the light homogenizing element is between two adjacent lenses of the at least one lens arranged at intervals of the first lens group, so as to homogenize light emitted from one of the two adjacent lenses and emit the light to the other of the two adjacent lenses.

According to an embodiment of the present disclosure, the at least one lens includes a first lens and a second lens, and a focal point of the first lens coincides with a focal point of the second lens, the light homogenizing element is between the first lens and the second lens and at the focal point, the first lens is on a light incident side of the light homogenizing element and configured to converge the light emitted from the light-spot shaping lens group, and the second lens is on a light exit side of the light homogenizing element and configured to collimate the light emitted from the light homogenizing element.

According to an embodiment of the present disclosure, the light homogenizing assembly further includes a collimating lens group and a third light homogenizing member configured for homogenizing light, the third light homogenizing member is on a light exit side of the first lens group or the light exit side of the light homogenizing element, and the collimating lens group is on a light exit side of the third light homogenizing member and includes at least one collimating lens.

According to an embodiment of the present disclosure, the first lens group further includes a third lens, the third lens is on a light exit side of the second lens and configured to converge light, and the third light homogenizing member is on a light exit side of the third lens and located at a focal point of the third lens.

According to an embodiment of the present disclosure, the first light homogenizing member includes a compound eye lens, the light homogenizing element includes a diffusion sheet, and the third light homogenizing member includes a light rod.

According to an embodiment of the present disclosure, the first lens group includes a first lens, the first lens is configured to converge light, the light homogenizing element is on a light exit side of the first lens and at a focus point of the first lens, the light homogenizing assembly further includes a third light homogenizing member, and the third light homogenizing member is on a light exit side of the light homogenizing element and disposed close to the focus point of the first lens.

According to an embodiment of the present disclosure, the light homogenizing assembly further includes a diffusion sheet, and the diffusion sheet is on a light incident side of the first light homogenizing member or a light exit side of the first light homogenizing member.

According to an embodiment of the present disclosure, the light homogenizing assembly further includes a diffusion sheet, and the diffusion sheet is on the light incident side of the second light homogenizing member or a light exit side of the second light homogenizing member.

According to an embodiment of the present disclosure, each of the first light homogenizing member and the second light homogenizing member is configured as a compound eye lens.

Embodiments of the first aspect of the present disclosure provide the light homogenizing assembly. First, the first light homogenizing member can homogenize the light emitted by the light source, perform first-level homogenization on the light, reduce speckle phenomenon of the light, and improve uniformity of the light is improved. Secondly, the light-spot shaping lens of the light-spot shaping lens group can shape the light spot of the light emitted from the first light homogenizing member and emit the light spot to the light incident side of the second light homogenizing member, so that light of different spaces and angles can be redistributed or combined, thereby facilitating the elimination of speckle. In addition, the light emitted from the light-spot shaping lens group can be further homogenized by arranging the second homogenizing member, and so that the light is homogenized at a second level, the speckle phenomenon of the light is further reduced, and the uniformity of the light is improved.

An embodiment of a second aspect of the present disclosure proposes a projection optical unit. The projection optical unit includes a light source, an imaging assembly and the light homogenizing assembly, the light source is on a light incident side of the light homogenizing assembly, and the imaging assembly is on a light exit side of the light homogenizing assembly to perform imaging processing on the light emitted from the light homogenizing assembly light source light source.

According to an embodiment of the present disclosure, the light source includes a light combining element and a plurality of light emitting elements, each of the plurality of light emitting elements is configured to emit light of different colors, and the light combining element is configured to combine the light of different colors emitted by the plurality of light emitting elements into white light

An embodiment of a third aspect of the present disclosure proposes a projection device. The projection device includes the projection optical unit.

### BRIEF DESCRIPTION OF THE DRAWINGS

The above and/or additional aspects and advantages of the present disclosure will become apparent and easily understood from the following description of the embodiments in conjunction with the accompanying drawings, in which:

FIG. 1 is a schematic structural diagram of a light homogenizing assembly according to an embodiment of the present disclosure;

FIG. 2 is a schematic structural diagram of a projection optical unit according to a first embodiment of the present disclosure;

FIG. 3 is a schematic structural diagram of a projection optical unit according to a second embodiment of the present disclosure;

FIG. 4 is a schematic structural diagram of a projection optical unit according to a third embodiment of the present disclosure;

FIG. 5 is a schematic structural diagram of a projection optical unit according to a fourth embodiment of the present disclosure.

### DETAILED DESCRIPTION OF THE EMBODIMENTS

The technical solutions in the embodiments of the present disclosure will be clearly and completely described below with reference to the accompanying drawings in the embodiments of the present disclosure. Obviously, the embodiments described are a part but not all the embodiments of the present disclosure. All other embodiments obtained by a person of ordinary skill in the art based on the embodiments in the present disclosure without creative efforts shall fall within the protection scope of the present disclosure.

It should be noted that when a component is referred to as being “fixed to” another component, it may be directly on another component, or there may be an intermediate component. When a component is considered to be “connected” to another component, it may be directly connected to another component or there may be an intermediate at the same time.

It should be noted that the concepts such as “first” and “second” mentioned in the present disclosure are only used to distinguish different devices, modules or units, and are not intended to limit the order or interdependency relationship of functions performed by these devices, modules or units.

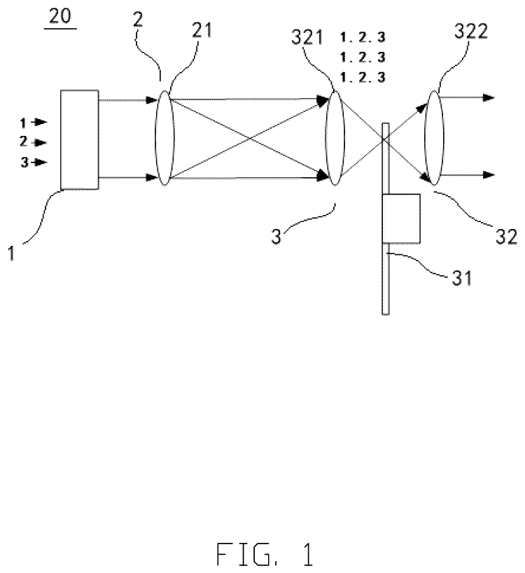

As shown in FIG. 1 through FIG. 5, the present disclosure provides a light homogenizing assembly. The light homogenizing assembly includes a first light homogenizing member 1, a light-spot shaping lens group 2 and a second light homogenizing member 3 which are sequentially arranged along an optical path. The first light homogenizing member 1 is used for homogenizing light emitted by a light source 10. The light-spot shaping lens group 2 includes at least one light-spot shaping lens 21, and at least one light-spot shaping lens 21 is used for converging light emitted from the first light homogenizing member 1 on a light incident side of the second light homogenizing member 3. The second light homogenizing member 3 is used for homogenizing light emitted from the light-spot shaping lens group 2.

In the above technical solution, first, the first light homogenizing member 1 can homogenize the light emitted by the light source 10, perform a first-level homogenization on the light, reduce the speckle phenomenon of the light, and improve the uniformity of light. Secondly, the light-spot shaping lens 21 of the light-spot shaping lens group 2 can shape the light spot of the light emitted from the first light homogenizing member 1 (that is, adjust a shape of the profile of the light) and emit the light to the light incident side of the second light homogenizing member 3, so that light of different spaces and angles can be redistributed or combined, thereby facilitating the elimination of speckles. In addition, the light emitted from the light-spot shaping lens group 2 can be further homogenized by arranging the second light homogenizing member 3, so that the light is homogenized at a second level, the speckle phenomenon of light is further reduced, and the uniformity of light is improved.

The light-spot shaping lens 21 can be a convex lens or a concave lens, as long as the purpose of shaping the light spot shape can be achieved, which is not limited in the present disclosure.

The first light homogenizing member 1 and the third light homogenizing member 3 may be configured as any suitable light homogenizing device, for example, may be configured as a compound eye lens, a micro-structure lens array, ground glass, a light rod, a diffusion sheet, etc., which is not limited in the present disclosure.

In one embodiment, as shown in FIG. 1, the second light homogenizing member 3 includes a light homogenizing element 31 and a first lens group 32. The first lens group 32 includes at least one lens, and the at least one lens is used for focusing or collimating light. The light homogenizing element 31 is on a light incident side of the first lens group 32, so as to homogenize the light emitted from the light-spot shaping lens group 2; or the light homogenizing element 31 is on a light exit side of the first lens group 32, so as to homogenize the light emitted from the first lens group 32; or the light homogenizing element 31 is between two adjacent lenses arranged at intervals in the first lens group 32, so as to homogenize the light emitted from one of the two adjacent lenses and emit the light to the other of the two adjacent lenses.

In one embodiment, when the light homogenizing element 31 is on the light exit side of the first lens group 32, the first lens group 32 may focus and/or collimate the light emitted from the light-spot shaping lens group 2, so as to meet the light incident requirement of the light incident side of the light homogenizing element 31, and specifically focus or collimate the light may be set according to requirements, which is not limited in the present disclosure.

In other embodiments, when the light homogenizing element 31 is on the light incident side of the first lens group 32, the light homogenized by the light homogenizing element 31 is emitted to the first lens group 32 and is focused and/or collimated to meet the light incident requirement of a subsequent imaging device.

In other embodiments, when the light homogenizing element 31 is between two adjacent lenses arranged at intervals, for example, a lens on a front side of the light homogenizing element 31 may focus light, and a lens on a rear side of the light homogenizing element 31 may collimate light; or the lens on the front side of the light homogenizing element 31 may collimate light, and the lens on the rear side of the light homogenizing element 31 may focus light.

Alternatively, as shown in FIG. 1, two lenses are provided in the first lens group 32 and are respectively a first lens 321 and a second lens 322. A focal point of the first lens 321 coincides with a focal point of the second lens 322, the homogenizing element 31 is between the first lens 321 and the second lens 322 and located at the focal point. The first lens 321 is on a light incident side of the light homogenizing element 31 and configured to converge the light emitted from the light-spot shaping lens group 2. The second lens 322 is on a light exit side of the light homogenizing element 31 and configured to collimate the light emitted from the light homogenizing element 31.

In the present embodiment, because the first lens 321 is on the light incident side of the light homogenizing element 31 and is configured to converge the light, the light is effectively converged at the focal point of the first lens 321, and the light homogenizing element 31 is at the focal point of the first lens 321, so that the converged light can be homogenized and decoherent. The problem of the light homogenizing element 31 that the light cannot be emitted to all directions due to light diffusion and other reasons is effectively avoided. The second lens 322 is on the light exit side of the light homogenizing element 31, so that light emitted from the light homogenizing element 31 can be collimated, a divergence angle of the light is reduced, and light transmission is facilitated.

As shown in FIG. 1, for example, the first light homogenizing member 1 can be configured as a compound eye lens, the light-spot shaping lens 21 of the light-spot shaping lens group 2 can be one, the first lens group 32 can include the first lens 321 and the second lens 322, and the light leveling element 31 can be at the focal point of the first lens 321 and the focal point of the second lens 322. Approximately parallel and separate red, green, and blue beams (shown as 1/2/3 in the figure) irradiate the compound eye lens from the left side, and each small unit lens in the compound eye lens diverges the light beam and then refracted by the light-spot shaping lens 21 to the first lens 321. Each spatial region of the first lens 321 includes light beam information of each small unit lens irradiated into the compound eye lens, so that the light homogenizing effect and the decoherence effect can be greatly enhanced after the light is homogenized through the light homogenizing element 31.

In the related art, the light beam is usually directly emitted to the light homogenizing element 31, which can only homogenize the light beam within a certain angle range or within a certain spatial region and cannot make all the light beams be completely homogenized and de-coherent, so that the emitted light beam also retains relatively strong coherence, which can bring speckles and color non-uniformity. By adopting the light homogenizing assembly of the present disclosure, all the light beams can be completely homogenized and de-coherent.

The first lens 321 and the second lens 322 can also constitute a Kepler telescope system, and the light homogenizing element 31 is at a focal position between the first lens 321 and the second lens 322. The light homogenizing element 31 can be configured as a static diffusion sheet or a dynamic diffusion wheel or a translational diffusion sheet, etc., and the present disclosure does not limit the specific type of the light homogenizing element 31.

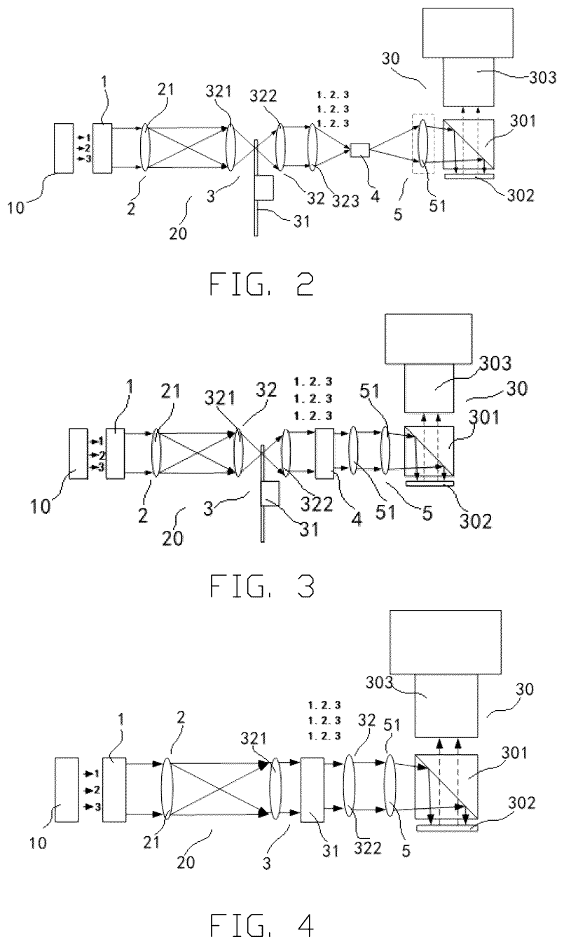

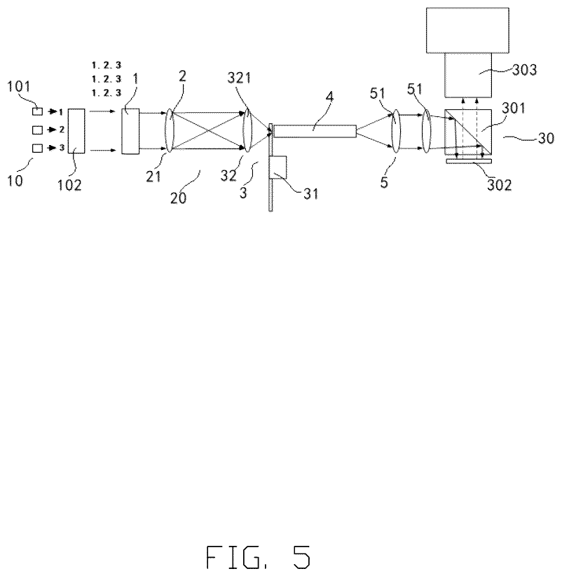

As shown in FIG. 2, FIG. 3 and FIG. 5, the light homogenizing assembly 20 further includes a collimating lens group 5 and a third light homogenizing member 4 for homogenizing light, the third light homogenizing member 4 is on the light exit side of the first lens group 32 or the light exit side of the light homogenizing element 31, and the collimating lens group 5 is on the light exit side of the third light homogenizing member 4 and includes at least one collimating lens 51.

In the present embodiment, first, the third light homogenizing member 4 is on the light exit side of the first lens group 32 or the light exit side of the light homogenizing element 31, and the third light homogenizing member 4 can further homogenize the light homogenized by the homogenization element 31, and the homogenizing effect and the decoherence effect are further improved. Secondly, by arranging the collimating lens group S, the homogenized light emitted from the third light homogenizing member 4 can be collimated, thereby reducing the divergence angle of the light and facilitating the transmission of light.

In other embodiments, as shown in FIG. 2, the first lens group 32 further includes a third lens 323, the third lens 323 is on a light exit side of the second lens 322 and configured for converging light, and the third light homogenizing member 4 is on a light exit side of the third lens 323 and at a focal point of the third lens 323.

That is, on the basis of the first lens 321 and the second lens 322, the first lens group 32 further includes the third lens 323, the third lens 323 can converge light emitted from the second lens 322, and all light emitted from the third lens 323 can be homogenized by arranging the third light homogenizing member 4 at the focal point of the third lens 323, thereby further improving the homogenization effect.

As shown in FIG. 5, the first lens group 32 includes the first lens 321, the first lens 321 is configured to converge light, the light homogenizing element 31 is on the light exit side of the first lens 321 and located at the focal point of the first lens 321. The light homogenizing assembly further includes a third light homogenizing member 4, and the third light homogenizing member 4 is on the light exit side of the light homogenizing element 4 and is close to the focal point of the first lens 321.

By arranging the light homogenizing element 31 at the focal point of the first lens 321 and the third light homogenizing member 4 close to the focal point of the first lens 321, the homogenizing element 31 and the third light homogenizing member 4 jointly homogenize the light converged by the first lens 321, thereby further improving the homogenization effect and improving the decoherence.

Optionally, the light homogenizing assembly 20 further includes a diffusion sheet (not shown), the diffusion sheet is on the light incident side of the first light homogenizing member 1 or the light exit side of the first light homogenizing member 1, or the diffusion sheet is on the light incident side of the second light homogenizing member 3 or the light exit side of the second light homogenizing member 3. By arranging the diffusion sheet, the light homogenizing effect of the light homogenizing assembly 20 can be further improved.

As shown in FIG. 2 through FIG. 5, the present disclosure further provides a projection optical unit. The projection optical unit includes a light source 10, an imaging assembly 30 and a light homogenizing assembly 20. Light emitted by the light source 10 is on the light incident side of the light homogenizing assembly 20, and the light incident side of the imaging assembly 30 is on the light exit side of the light homogenizing assembly 20 to perform imaging processing on light emitted from the light homogenizing assembly 20. The imaging assembly 30 may include a prism 301, an imaging chip 302 and a lens 303.

For example, as shown in FIG. 2, the projection optical unit is provided, the first light homogenizing member 1 is configured as a compound eye lens, the light-spot shaping lens group 2 includes a light-spot shaping lens 21, the second light homogenizing member 3 includes a first lens 321 for focusing light, a second lens 322 for collimating light, a third lens 323 for focusing light, and a light homogenizing element 31 configured as a diffusion wheel. The diffusion wheel is at the coincidence of the focal point of the first lens 321 and the focal point of the second lens 322. The third light homogenizing member 4 is configured as a light rod and on the light exit side of the third lens 323, and a light incident side of the third light homogenizing member 4 is at the focal point of the third lens 323.

The laser beams of three different colors, red, green and blue, emitted by the light source 10 are respectively represented by the number 1/2/3. After the light beams of different colors pass through the compound eye lens and the light-spot shaping lens 21, a white light spot is formed by approximately synthesizing different light beams of red, green and blue on the light incident side of the first lens 321, and the emitted white light spot is more uniform and de-coherent due to the existence of the diffusion wheel. Light is emitted from the third lens 323 and converged to the light incident side of the light rod, and then passes through the collimating lens 51 to be emitted to the imaging assembly 30. The light emitted from the collimating lens 51 is emitted to the prism 301, and the prism 301 emits the light to the imaging chip 302, and then the imaging chip 302 transmits the received light to the lens 303 through a total internal reflection (TIR) prism for imaging. Optionally, the light source 10 may be configured as a light-emitting element such as a light-emitting diode, which is not limited in the present disclosure.

Optionally, a length-width ratio of the light rod can match a length-width ratio of an imaging area of the imaging chip 302.

In other embodiments, as shown in FIG. 3, the first light homogenizing member 1 is configured as a first compound eye lens, the light-spot shaping lens group 2 includes a light-spot shaping lens 21. The second light homogenizing member 3 includes a first lens 321 for focusing light, a second lens 322 for collimating light, and a light homogenizing element 31 configured as a diffusion wheel. The diffusion wheel is at the coincidence of the focal point of the first lens 321 and the focal point of the second lens 322. The third light homogenizing member 4 is configured as a second compound eye lens and is on the light exit side of the second lens 322, and the collimating lens group 5 includes two collimating lenses 51.

The laser beams of three different colors, red, green and blue, emitted by the light source 10 are respectively represented by the number 1/2/3. After the light beams of different colors pass through the first compound eye lens and the light-spot shaping lens 21, a white light spot is formed by approximately synthesizing different light beams of red, green and blue on the light incident side of the first lens 321, and the emitted white light spot is more uniform and de-coherent due to the existence of the diffusion wheel. After being emitted from the second lens 322, the light is further homogenized through the second fly-eye lens, then the light is collimated by the two collimating lenses 51. After passing through the two collimating lenses 51, the light is emitted to the prism 301. The prism 301 emits the light to the imaging chip 302, and then the imaging chip 302 emits received light to the lens 303 through the prism for imaging.

Optionally, the length-width ratio of the small unit lens of the second compound eye lens matches the length-width ratio of the imaging area of the imaging chip 302.

Alternatively, as shown in FIG. 4, the first light homogenizing member 1 is configured as a first compound eye lens, and the light-spot shaping lens group 2 includes a light-spot shaping lens 21, and the light-spot shaping lens 21 configured to converge light. The second light homogenizing member 3 includes a first lens 321, a second lens 322 and a light homogenizing element 31 configured as a second compound eye lens. Each of the first lens 321 and the second lens 322 is configured to collimate light, and the second compound eye lens is between the first lens 321 and the second lens 322. The collimating lens group 5 includes one collimating lens 51.

The laser beams of three different colors, red, green and blue, emitted by the light source 10 are respectively represented by the number 1/2/3. After the light beams of different colors pass through the first compound eye lens and the light-spot shaping lens 21, a white light spot is formed by approximately synthesizing different light beams of red, green and blue on the light incident side of the first lens 321, and the emitted white light spot is more uniform and de-coherent due to the existence of the second compound eye lens. After being emitted from the second lens 322, the light is emitted to the collimating lens 51 and is collimated by the collimating lens 51. After passing through the collimating lens 51, the light is emitted to the prism 301. The prism 301 emits the light to the imaging chip 302, and then the imaging chip 302 emits received light to the lens 303 through the prism for imaging. The length-width ratio of the small unit lens of the second compound eye lens can match the length-width ratio of the imaging area of the imaging chip 302.

In addition, the prism 301 can be configured as a total internal reflection (TIR) prism, or a polarization beam splitter (PBS) prism, and the imaging chip 302 can be configured as a digital micromirror device (DMD) chip or liquid crystal on silicon (LCOS) chip, which is not limited in the present disclosure.

In other modified embodiments, as shown in FIG. 5, the first light homogenizing member 1 is configured as a compound eye lens, the light-spot shaping lens group 2 includes a light-spot shaping lens 21, and the light-spot shaping lens 21 is used for converging the light. The second light homogenizing member 3 includes a first lens 321 and a light homogenizing element 31 configured as a diffusion wheel. The first lens 321 is used for converging light, and the diffusion wheel is at the focal point of the first lens 321. The light exit side of the diffusion wheel is provided with a third light homogenizing member 4 configured as a light rod, and a light incident side of the light rod is close to the focal point of the first lens 321. The collimating lens group 5 on the light exit side of the light rod includes two collimating lenses 51.

The laser beams of three different colors, red, green and blue, emitted by the light source 10 are respectively represented by the number 1/2/3. After the light beams of different colors pass through the compound eye lens and the light-spot shaping lens 21, a white light spot is formed by approximately synthesizing different light beams of red, green and blue on the light incident side of the first lens 321, and the emitted white light spot is more uniform and de-coherent due to the existence of the diffusion wheel. After being emitted from the light rod, the light is further homogenized through the light rod, then the light is collimated by the two collimating lenses 51. After passing through the collimating lenses 51, the light is emitted to the prism 301. The prism 301 emits the light to the imaging chip 302, and then the imaging chip 302 emits received light to the lens 303 through the prism for imaging.

Alternatively, as shown in FIG. 5, the light source 10 includes a light combining element 102 and a plurality of light emitting elements 101, each light emitting element 102 is configured to emit monochromatic beams of different colors, and the light combining element 101 is configured to combine a plurality of monochromatic light beams of different colors emitted by the plurality of light emitting elements 102 into a white light beam, thereby improving the uniformity of light color. For example, there may be three light-emitting elements 102 for emitting red, green, and blue beams respectively (denoted by numbers 1/2/3, respectively).

In addition, the compound eye lens may be a single-sided compound eye lens, a double-sided compound eye lens or a combination of two single-sided compound eye lens, which is not limited in the present disclosure. The light rod can be an optical material block of an entity, including but not limited to a cuboid and a cone, or maybe a reflective air channel formed by bonding a plurality of reflective lenses.

The present disclosure further provides a projection device, which includes the above projection optical unit.

The above are only embodiments of the present disclosure and are not therefore intended to limit the patent scope of the present disclosure, and any equivalent structure or equivalent process transformation made by using the description and drawings of the present disclosure, or directly or indirectly used in other related technical fields, are all similarly included in the patent protection scope of the present disclosure:

1. A light homogenizing assembly, characterized in that, the light homogenizing assembly comprises a first light homogenizing member, a light-spot shaping lens group, and a second light homogenizing member sequentially arranged along an optical path;
wherein the first light homogenizing member is configured to homogenize light emitted by a light source;
the light-spot shaping lens group comprises at least one light-spot shaping lens, the at least one light-spot shaping lens is configured to shape a light spot of light emitted from the first light homogenizing member and emit the light to a light incident side of the second light homogenizing member; and
the second light homogenizing member is configured to homogenize light emitted from the light-spot shaping lens group.

2. The light homogenizing assembly according to claim 1, wherein the second light homogenizing member comprises a light homogenizing element and a first lens group, the first lens group comprises at least one lens, and the lens is configured to focus or collimate light;
and the light homogenizing element is on a light incident side of the first lens group and configured to homogenize the light emitted from the light-spot shaping lens group.

3. The light homogenizing assembly according to claim 1, wherein the second light homogenizing member comprises a light homogenizing element and a first lens group, the first lens group comprises at least one lens, and the lens is configured to focus or collimate the light; and the light homogenizing element is on a light exit side of the first lens group and configured to homogenize light emitted from the first lens group.

4. The light homogenizing assembly according to claim 1, wherein the second light homogenizing member comprises a light homogenizing element and a first lens group, the first lens group comprises at least two lens, and the lens is configured to focus or collimate the light; and the light homogenizing element is between two adjacent lenses of the at least one lens arranged at intervals of the first lens group, so as to homogenize light emitted from one of the two adjacent lenses and emit the light to the other of the two adjacent lenses.

5. The light homogenizing assembly according to claim 2, wherein the at least one lens comprises a first lens and a second lens, and a focal point of the first lens coincides with a focal point of the second lens, the light homogenizing element is between the first lens and the second lens and at the focal point of the first lens, the first lens is on a light incident side of the light homogenizing element and configured to converge the light emitted from the light-spot shaping lens group, and the second lens is on a light exit side of the light homogenizing element and configured to collimate the light emitted from the light homogenizing element.

6. The light homogenizing assembly according to claim 5 further comprising a collimating lens group and a third light homogenizing member configured for homogenizing light, the third light homogenizing member is on a light exit side of the first lens group or the light exit side of the light homogenizing element, and the collimating lens group is on a light exit side of the third light homogenizing member and comprises at least one collimating lens.

7. The light homogenizing assembly according to claim 6, wherein the first lens group further comprises a third lens, the third lens is on a light exit side of the second lens and configured to converge light, and the third light homogenizing member is on a light exit side of the third lens and located at a focal point of the third lens.

8. The light homogenizing assembly according to claim 7, wherein the first light homogenizing member comprises a compound eye lens, the light homogenizing element comprises a diffusion sheet, and the third light homogenizing member comprises a light rod.

9. The light homogenizing assembly according to claim 2, wherein the first lens group comprises a first lens, the first lens is configured to converge light, the light homogenizing element is on a light exit side of the first lens and at a focus point of the first lens, the light homogenizing assembly further comprises a third light homogenizing member, and the third light homogenizing member is on a light exit side of the light homogenizing element and disposed close to the focus point of the first lens.

10. The light homogenizing assembly according to claim 1 further comprising a diffusion sheet, wherein the diffusion sheet is on a light incident side of the first light homogenizing member or a light exit side of the first light homogenizing member.

11. The light homogenizing assembly according to claim 1 further comprising a diffusion sheet, wherein the diffusion sheet is on the light incident side of the second light homogenizing member or a light exit side of the second light homogenizing member.

12. The light homogenizing assembly according to claim 1, wherein each of the first light homogenizing member and the second light homogenizing member is configured as a compound eye lens.

13. A projection optical unit comprising a light source, an imaging assembly, and a light homogenizing assembly, wherein the light source is on a light incident side of the light homogenizing assembly, and the imaging assembly is on a light exit side of the light homogenizing assembly to perform imaging processing on light emitted from the light homogenizing assembly;
the light homogenizing assembly comprises a first light homogenizing member, a light-spot shaping lens group, and a second light homogenizing member sequentially arranged along an optical path;
the first light homogenizing member is configured to homogenize light emitted by the light source;
the light-spot shaping lens group comprises at least one light-spot shaping lens, the at least one light-spot shaping lens is configured to shape a light spot of light emitted from the first light homogenizing member and emit the light to a light incident side of the second light homogenizing member; and
the second light homogenizing member is configured to homogenize light emitted from the light-spot shaping lens group.

14. The projection optical unit according to claim 13, wherein the light source comprises a light combining element and a plurality of light emitting elements, each of the plurality of light emitting elements is configured to emit light of different colors, and the light combining element is configured to combine the light of different colors emitted by the plurality of light emitting elements into white light.

15. A projection device comprising a projection optical unit, the projection optical unit comprising a light source, an imaging assembly, and a light homogenizing assembly, wherein the light source is on a light incident side of the light homogenizing assembly, and the imaging assembly is on a light exit side of the light homogenizing assembly to perform imaging processing on light emitted from the light homogenizing assembly;
the light homogenizing assembly comprises a first light homogenizing member, a light-spot shaping lens group, and a second light homogenizing member sequentially arranged along an optical path;
the first light homogenizing member is configured to homogenize light emitted by the light source;
the light-spot shaping lens group comprises at least one light-spot shaping lens, the at least one light-spot shaping lens is configured to shape a light spot of light emitted from the first light homogenizing member and emit the light to a light incident side of the second light homogenizing member; and
the second light homogenizing member is configured to homogenize light emitted from the light-spot shaping lens group.

16. The light homogenizing assembly according to claim 2 further comprising a diffusion sheet, wherein the diffusion sheet is on the light incident side of the second light homogenizing member or a light exit side of the second light homogenizing member.

17. The projection optical unit according to claim 13, wherein the light homogenizing assembly further comprises a diffusion sheet, wherein the diffusion sheet is on the light incident side of the second light homogenizing member or a light exit side of the second light homogenizing member.

18. The projection optical unit according to claim 13, wherein each of the first light homogenizing member and the second light homogenizing member is configured as a compound eye lens.

19. The projection device according to claim 15, wherein the light homogenizing assembly further comprises a diffusion sheet, wherein the diffusion sheet is on the light incident side of the second light homogenizing member or a light exit side of the second light homogenizing member.

20. The projection device according to claim 15, wherein each of the first light homogenizing member and the second light homogenizing member is configured as a compound eye lens.
